(19) United States
(12) Patent Application Publication
(10) Pub. No.: US 2020/0020042 A1
(43) Pub. Date: Jan. 16, 2020

(54) METHODS FOR IMPROVED EMBEZZLEMENT RISK MODELING TO FACILITATE INSURANCE-BASED ASSET PROTECTION AND DEVICES THEREOF

(71) Applicant: Capital Shield Inc., Wilmington, DE (US)

(72) Inventors: James M. Foglio, Miromar Lakes, FL (US); Travus H. Pope, Naples, FL (US)

(21) Appl. No.: 16/507,922

(22) Filed: Jul. 10, 2019

Related U.S. Application Data
(60) Provisional application No. 62/697,554, filed on Jul. 13, 2018.

(51) Int. Cl. G06Q 40/08; G06Q 40/06

(52) U.S. Cl. CPC G06Q 40/08; G06Q 40/06

(57) ABSTRACT

Methods, non-transitory computer readable media, and embezzlement risk analysis devices that improve embezzlement risk modeling to facilitate insurance-based asset protection. With this technology, embezzlement risk data is retrieved for a trusted entity in response to an insurance underwriting request received via communication network(s). The embezzlement risk data is retrieved from one or more embezzlement risk data source devices via other communication network(s). Weighting factor(s) are applied to characteristic(s) of disclosable event(s) extracted from the retrieved embezzlement risk data to generate at least one risk score reflective of a risk of loss of financial assets made available to the trusted entity. The risk score is output in response to the insurance underwriting request and via the communication network(s). Optionally, the risk score can be used to automatically generate an insurance underwriting decision and/or an electronic insurance policy document.

This application claims the benefit of U.S. Provisional Patent Application Ser. No. 62/697,554, filed on Jul. 13, 2018, which is hereby incorporated by reference in its entirety.

### FIELD

This technology generally relates to methods and devices for improved, automated embezzlement risk modeling to facilitate insurance-based asset protection.

### BACKGROUND

Many types of insurance products exist that facilitate the protection of assets with respect to the occurrence of adverse events. Some types of insurance products protect physical assets, such as homes and automobiles. Other types of insurance products protect against identity theft or employee theft, for example. However, insurance is not currently available to protect personal financial assets or investments from being stolen or embezzled by a joint business owner, advisor, agent, partner, business affiliate, or other trusted entity.

Such insurance is not available at least because there is no effective way to model or determine risk for an investor of personal financial assets that can inform the insurance underwriting process, let alone in an automated, scalable way for relatively large volumes of applications and associated data. Accordingly, investors often make financial assets available to a trusted entity without any awareness of potential risks and/or any protection against loss of those assets as a result of embezzlement, for example, by the trusted entity.

### BRIEF DESCRIPTION OF THE DRAWINGS

FIG. 1 is a block diagram of an exemplary network environment with an embezzlement risk analysis device;

FIG. 2 is a flowchart of an exemplary method for embezzlement risk modeling to facilitate insurance-based asset protection;

FIG. 3 is an exemplary trusted entity graphical user interface (GUI) for facilitating receipt of trusted entity data;

FIG. 4 is an exemplary coverage GUI for facilitating receipt of coverage data; and

FIG. 5 is an exemplary flow diagram of an exemplary method for embezzlement risk modeling to facilitate insurance-based asset protection.

### DETAILED DESCRIPTION

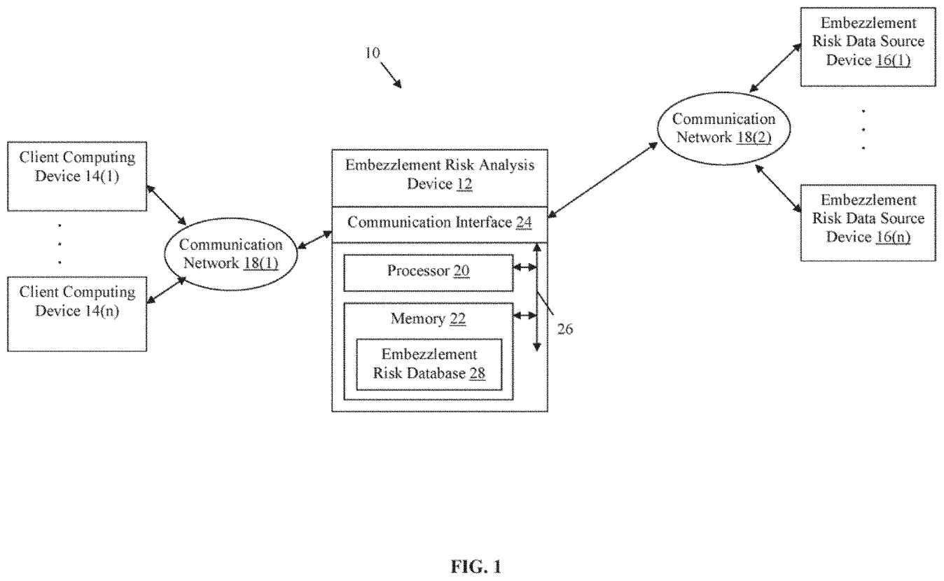

An exemplary network environment 10 with an embezzlement risk analysis device 12 coupled to client computing devices 14(1)-14(n) and embezzlement risk data source devices 16(1)-16(n) by communication networks 18(1) and 18(2) is illustrated in FIG. 1, although this network environment 10 can include other numbers and types of systems, devices, and elements in other configurations. While not shown, the network environment 10 also may include additional network components such as routers and switches, which are well known to those of ordinary skill in the art and thus will not be described here. This technology provides a number of advantages including methods, non-transitory computer readable media, and devices that more effectively model risk associated with making financial assets available to a trusted entity in order to inform insurance underwriting decisions and facilitate asset protection via insurance policies.

The embezzlement risk analysis device 12 in this example includes a processor 20, a memory 22, and a communication interface 24, which are coupled together by a bus 26 or other communication link, although other numbers and types of systems, devices, components, and elements in other configurations and locations can also be used. The processor 20 in the embezzlement risk analysis device 12 executes a program of stored instructions for one or more aspects of the present technology, as described and illustrated by way of the examples herein, although other types and numbers of processing devices and configurable hardware logic could be used and the processor 20 could execute other numbers and types of programmed instructions.

The memory 22 in the embezzlement risk analysis device 12 stores these programmed instructions for one or more aspects of the present technology as described and illustrated herein, although some or all of the programmed instructions could be stored and executed elsewhere. A variety of different types of memory storage devices, such as a RAM, ROM, hard disks, flash, solid state drives, or other computer readable medium which is read from and written to by a magnetic, optical, or other reading and writing system that is coupled to the processor 20, can be used for the memory 22.

In this example, the memory 22 includes an embezzlement risk database 28.

The embezzlement risk database 28 is a repository for embezzlement risk data including background check and disclosable event data, and other information reflective of the trustworthiness of the person or entities identified therein, which is obtained from the embezzlement risk data source devices 16(1)-16(n). Optionally, the embezzlement risk database 28 can also store one or more risk scores associated with each of the persons or entities identified therein, which can be generated based on the embezzlement risk data and used to inform underwriting decisions, as described and illustrated in more detail later. In other examples, the memory 22 can store other information in other formats, and the information stored in the embezzlement risk database 28 can also be stored elsewhere.

The communication interface 24 in the embezzlement risk analysis device 12 is used to operatively couple and communicate between the embezzlement risk analysis device 12, the client computing devices 14(1)-14(n) and the embezzlement risk data source devices 16(1)-16(n) via the communication networks 18(1) and 18(2), although other types and numbers of connections and configurations can also be used. By way of example only, the communication networks 18(1) and 18(2) can include one or more local area networks or wide area networks, for example, and can use TCP/IP over Ethernet and industry-standard protocols, including hypertext transfer protocol (HTTP) and secure HTTP (HTTPS), although other types and numbers of communication networks, such as a direct connection, modems and phone lines, e-mail, and wireless and hardwire communication technology, each having their own communications protocols, can also be used.

The client computing devices 14(1)-14(n) in this example each include a processor, a memory, a communication interface, an input device, and a display device, which are coupled together by a bus or other communication link. The client computing devices 14(1)-14(n) can also have other numbers and types of systems, devices, components, and elements in other configurations and locations. The client computing devices 14(1)-14(n) can be mobile computing devices, smartphones, tablets, laptops, desktop computers, or any combination thereof. Investors can use the client computing devices 14(1)-14(n) to interface with the embezzlement risk analysis device 12 to request insurance coverage and other information regarding a joint business owner, advisor, partner, or other trusted entity, for example, as described and illustrated in more detail later.

The embezzlement risk data source devices 16(1)-16(n) in this example each include a processor, a memory, and a communication interface, which are coupled together by a bus or other communication link. The embezzlement risk data source devices 16(1)-16(n) can also have other numbers and types of systems, devices, components, and elements in other configurations and locations. In some examples, the embezzlement risk data source devices 16(1)-16(n) include one or more server computing devices hosted by providers of embezzlement risk data, such as disclosable events associated with trusted entities. Accordingly, one or more of the embezzlement risk data source devices 16(1)-16(n) can be associated with a government entity (e.g., the Securities and Exchange Commission (SEC)), associated with a self-regulatory organization SRO (e.g., the Financial Industry Regulatory Authority)) or an independent, third party organization (e.g., Certified Financial Planner (CFP) Board of Standards).

Although examples of the embezzlement risk analysis device 12, client computing devices 14(1)-14(n) and the embezzlement risk data source devices 16(1)-16(n), which are coupled together via the communication networks 18(1) and 18(2), are described herein, other types and/or numbers of computer systems or computing devices can also be used. It is to be understood that the devices and systems of the examples described herein are for exemplary purposes, as many variations of the specific hardware and software used to implement the examples are possible, as will be appreciated by those skilled in the relevant art(s).

In addition, two or more computing systems or devices can be substituted for any one of the systems in any embodiment of the examples. The examples may also be implemented on computer device(s) that extend across any suitable network using any suitable interface mechanisms and communications technologies, including by way of example only telecommunications in any suitable form (e.g., voice and modem), wireless communications media, wireless communications networks, cellular communications networks, 3G, 4G, or 5G communications networks, Public Switched Telephone Network (PSTNs), Packet Data Networks (PDNs), the Internet, intranets, or combinations thereof.

The examples may also be embodied as a non-transitory computer readable medium, such as the memory 22, having programmed instructions stored thereon for one or more aspects of the present technology as described and illustrated by way of the examples herein. The programmed instructions, when executed by a processor, such as the processor 20, cause the processor to carry out the steps necessary to implement one or more methods of the examples, as described and illustrated herein.

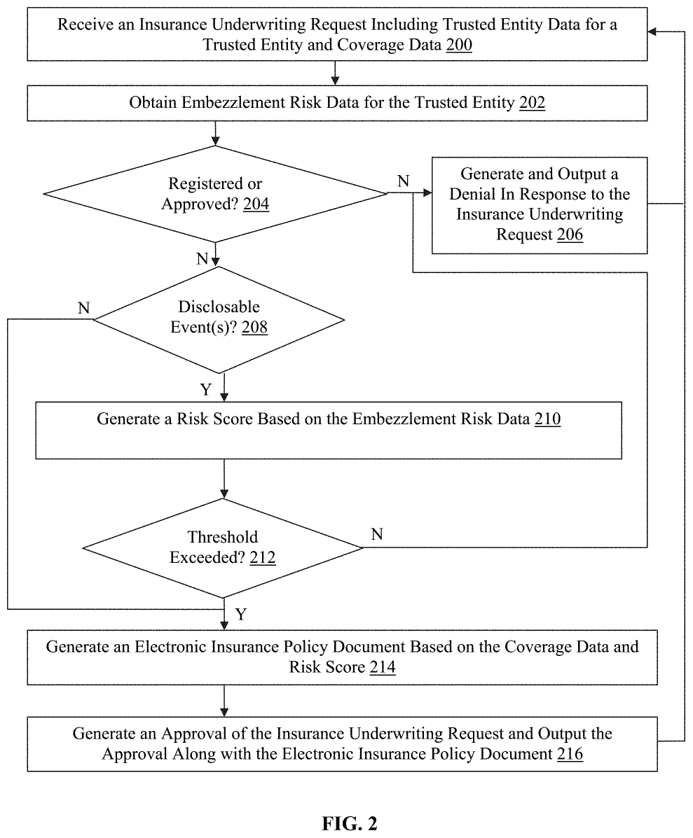

An exemplary method for embezzlement risk modeling to facilitate insurance-based asset protection will now be described with reference to FIG. 2. In step 200 in this particular example, the embezzlement risk analysis device 12 receives an insurance underwriting request from one of the client computing devices 14(1)-14(n) via the communication network 18(1). The underwriting request in this example includes trusted entity data for at least one joint business owner, advisor, partner, or any other person or entity to which financial assets may be, or have been, made available (commonly referred to herein as a trusted entity) by an investor, for example, along with coverage data regarding the financial assets.

The insurance underwriting request could have been sent by a user of one of the client computing devices 14(1)-14(n) interfacing with a web application or web page provided by the embezzlement risk analysis device 12, for example. The user of the one of the client computing devices 14(1)-14(n) can be an investor or other person interested in making, or that has previously made, the financial assets available to the trusted entity, such as for financial management or investment purposes, for example.

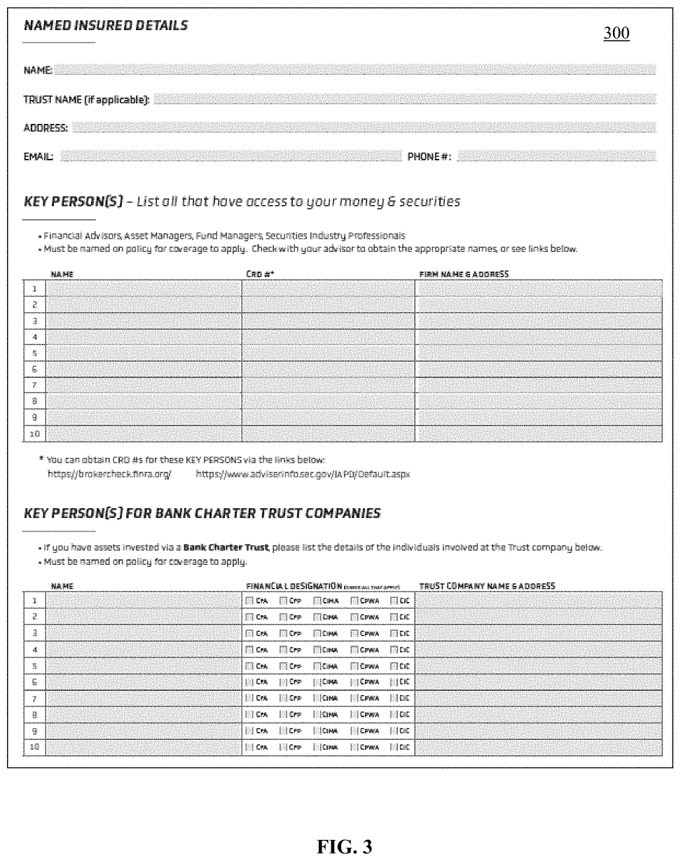

Referring to FIG. 3, an exemplary trusted entity graphical user interface (GUI) 300 for facilitating receipt of trusted entity data is illustrated. In this example, the trusted entities include key person(s) having access to money and securities financial assets, including key person(s) associated with bank charter trust companies. The trusted entity data submitted via the trusted entity GUI 300 in this example includes trusted entity name, Central Registration Depository (CRD) number, financial designation(s), and/or firm or trust company name and address, although the trusted entity data can include other information in other examples. The trusted entity GUI 300 can also be used by a user of one of the client computing devise 14(1)-14(n) to provide insured data such as investor or trust name, address, and contact information, for example.

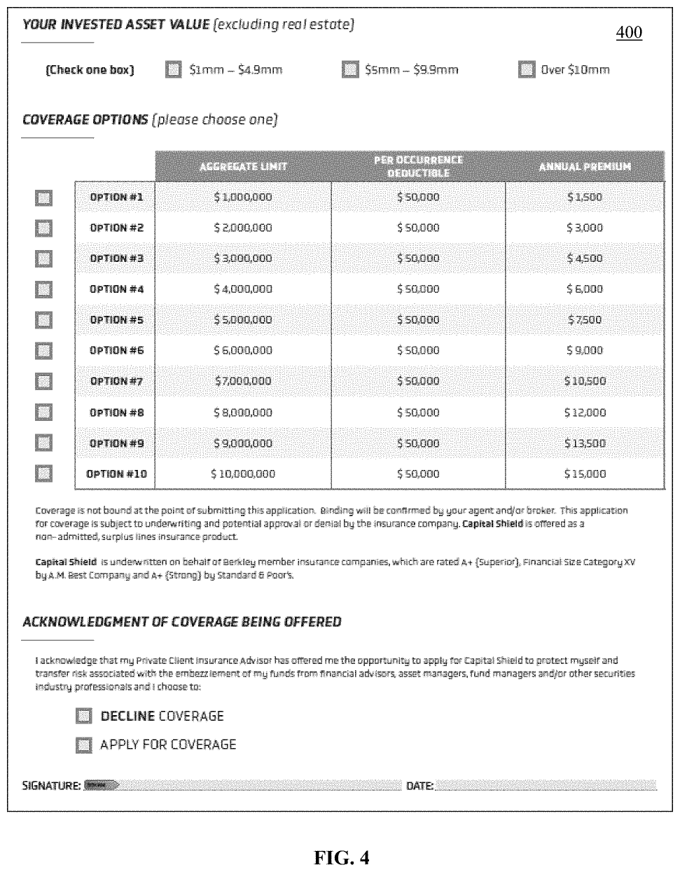

Referring to FIG. 4, an exemplary coverage GUI 400 for facilitating receipt of coverage data is illustrated. The coverage data submitted via the coverage GUI 400 in this example includes an invested asset value and coverage options, although other types of coverage data can also be obtained in other example. The coverage data can include information regarding the assets that the investor user of the one of the client computing devices 14(1)-14(n) will make, or has made, available to one or more trusted entities, such as the size and composition of the assets, for example, although other types of characteristics regarding the assets can also be included in the coverage data in other examples.

Referring back to FIG. 2, in step 202, the embezzlement risk analysis device 12 attempts to obtain embezzlement risk data for the trusted entity in response to the insurance underwriting request. While embezzlement risk data is obtained for only one trusted entity in this example, embezzlement risk data can be obtained in step 202, and utilized to generate a risk score as described and illustrated in more detail later with reference to step 210, for any number of trusted entities in other examples. In some examples, the CRD number and/or financial designation(s) included in the trusted entity data obtained in step 200 can be used to identify a particular subset of the embezzlement risk data source devices 16(1)-16(n) from which at least a portion of the embezzlement risk data is obtained in step 202, although other types of queries based on other parameters can also be used.

The embezzlement risk data can be obtained from one or more of the embezzlement risk data source devices 16(1)-16(n) using one or more application programming interfaces (APIs) made available by the embezzlement risk data source devices 16(1)-16(n), and can include background check information, information regarding historical investment performance, adverse events related to historical investments associated with the trusted entity, and/or litigation history of the trusted entity, for example, which are collectively referred to herein as disclosable events. The embezzlement risk data source devices 16(1)-16(n) can be associated with public, government, private, independent, and/or third party domains.

In some examples, one or more portions of the data can be obtained from one of more embezzlement risk data source devices 16(1)-16(n) associated with government entities, such as the SEC, Financial Industry Regulatory Authority, Inc. (FINRA), and U.S. Commodity Futures Trading Commission (CFTC), for example. In other examples, one or more portions of the data can be obtained from one of more embezzlement risk data source devices 16(1)-16(n) associated with independent entities such as the National Futures Association (NFA), North American Securities Administrators Association (NASAA), CRD, Investment Adviser Registration Depository (IARD) system, Investment Adviser Public Disclosure (IAPD) database, Chartered Financial Analyst (CFA) Institute, CFP Board of Standards, Chartered Institute of Management Accountants (CIMA), Investments and Wealth Institute (associated with the Certified Private Wealth Advisor (CPWA) designation) and/or National Alliance for Insurance Education and Research (associated with the Certified Insurance Counselor (CIC) designation), for example.

Additionally, one or more of the embezzlement risk data source devices 16(1)-16(n) can be associated with Radiant Analytics, Westlaw/Thompson Reuters and/or Lexus Nexus, Google, and/or one or more financial technology reporting companies, for example. Other types and numbers of embezzlement risk data can also be obtained in step 200 from one or more other types or numbers of the embezzlement risk data source devices 16(1)-16(n). In some examples, the embezzlement risk analysis device 12 also parses, converts, performs optical text recognition (OCR), transforms, sanitizes, and/or normalizes the obtained embezzlement risk data to harmonize or standardize the embezzlement risk data based on the various heterogeneous formats of portions of the embezzlement risk data obtained from different of the embezzlement risk data source devices 16(1)-16(n).

In step 204, the embezzlement risk analysis device 12 determines whether the trusted entity is registered or approved, and whether the attempt to obtain embezzlement risk data in step 202 was successful. For example, the risk analysis device 12 may query one of the embezzlement risk data source devices 16(1)-16(n) associated with the SEC based on a CRD number for the trusted entity provided in the trusted entity data received in step 200. A response from the one of the embezzlement risk data source devices 16(1)-16(n) may be unsuccessful, indicating that the trusted entity is not registered with the SEC. In another example, a query from the risk analysis device 12 to one or more of the embezzlement risk data source devices 16(1)-16(n) associated with different financial designations in the trusted entity data received in step 200 may be unsuccessful, indicating that there are no approved designations for the trusted entity. If the embezzlement risk analysis device 12 determines that the trusted entity is not registered or approved, then the No branch is taken to step 206.

In step 206, the embezzlement risk analysis device 12 generates and outputs a denial of the insurance underwriting request to the one of the client computing devices 14(1)-14(n) via the communication network(s) 18(1). Since the attempt to obtain embezzlement risk data for the trusted entity was unsuccessful, the trusted entity is not considered trustworthy and the financial assets are not insurable in this example. However, if the embezzlement risk analysis device 12 determines in step 204 that the trusted entity is registered or approved (i.e., the attempt to obtain embezzlement risk data in step 202 was successful), then the Yes branch is taken to step 208.

In step 208, the embezzlement risk analysis device 12 determines whether there are any disclosable event(s) in the embezzlement risk data obtained for the trusted entity in step 202. As explained in more detail earlier, the disclosable events may be civil, criminal, or regulatory in nature, for example, and may provide an indication of the trustworthiness of the trusted entity, which can be correlated with the insurability of the financial assets and/or policy cost, for example.

To determine whether any, or certain types of, disclosable events are represented in the obtained embezzlement risk data, the embezzlement risk analysis device 12 can perform a text analysis or comparison of converted or processed reports obtained in step 202 to a stored database or list of disclosable events, although other methods for automatically identifying the disclosable events in the embezzlement risk data can also be used in other examples. If the embezzlement risk analysis device 12 determines that there are disclosable event(s) associated with the trusted entity, then the Yes branch is taken to step 310.

In step 210, the embezzlement risk analysis device 12 generates at least one risk score associated with the trusted entity based on the embezzlement risk data obtained in step 202, including the characteristics of the identified disclosable event(s). The risk score can be any value or indicator that is reflective of a risk of loss of financial assets invested with the trusted entity due to a misappropriation (e.g., stealing or embezzling) of the assets by the trusted entity. Optionally, various weighting factors can be applied to one or more portions of the embezzlement risk data in order to generate the risk score, and other types and numbers of risk scores and/or methods of generating the risk score can be used in other examples.

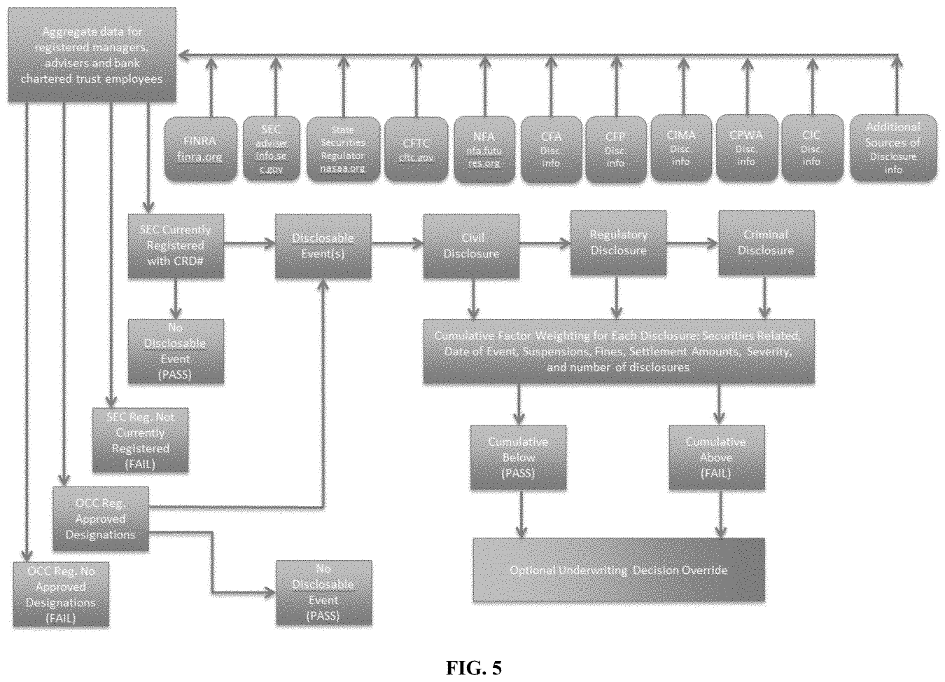

In some examples, business logic is applied to one or more portions of the obtained and processed embezzlement risk data for the trusted entity. The business logic can process the characteristics of the disclosable event(s), such as a fine amount, date of the event, settlement amount, and/or severity, for example, although other characteristics can be associated with the disclosable event(s) in other examples. Additionally, the business logic can apply weighting factors to the various disclosable event(s) including relative importance or applicability (e.g., a securities related offense versus a driving while intoxicated offense), for example, although other basis for the weighting factors can also be used. The result of the business logic is a risk score for the trusted entity, as described and illustrated in more detail later with reference to FIG. 5.

Additionally, the business logic can be based on an aggregate data set of qualifying advisers and managers, using the inputs of aggregate number of registered advisers with a current CRD number and the aggregate number of designees associated with independent entities, entered into a combined data pool. In this example, the business logic is based on historical data for embezzlements by such qualifying entities factored with aggregate exposure per qualified adviser and manager. Optionally, machine learning can be used to tune the business logic and optimize the analysis to improve the accuracy of the risk scores and associated applied logic.

Optionally, the embezzlement risk data is tagged for particular use cases or analysis types and analyzed to generate insights regarding the trusted entity relating to the risk assessment. One or more of the data sources associated with the embezzlement risk data source devices 16(1)-16(n) can be identified based on the tagged embezzlement risk data, and the data points are grouped using related statistical analytical formulas to generate a numerical risk score. This analysis can be expanded to multiple levels of formulas to analyze the risk of a trusted entity based on the weighting factors and the corresponding risk scores, as well as automated based on feedback and a machine learning process, for example.

The embezzlement risk analysis device 12 optionally stores the embezzlement risk data and the generated risk score, such as in the embezzlement risk database 28. The embezzlement risk data and/or risk score can be stored as associated with the trusted entity and optionally retrieved in step 202 and used in step 210 to generate a risk score for the trusted entity in a subsequent iteration and in response to another request for an underwriting decision from the one of the client computing devices 14(1)-14(n) or another one of the client computing devices 14(1)-14(n).

In step 212, the embezzlement risk analysis device 12 determines whether an established threshold risk score has been exceeded by the risk score generated in step 210. The threshold risk score can be stored in the memory 22 and can be used to determine whether to generate a positive or negative insurance underwriting decision for the investor, although other methods of determining whether to underwrite an insurance policy for the investor can also be used in other examples.

Accordingly, if the embezzlement risk analysis device 12 determines in step 212 that the generated risk score does not exceed the threshold risk score, then the No branch is taken to step 206, and the embezzlement risk analysis device 12 generates and outputs a denial in response to the underwriting request in this example, as described and illustrated in more detail earlier. However, if the embezzlement risk analysis device 12 determines in step 212 that the generated risk score does exceed the threshold risk score and the Yes branch is taken, or in step 208 that there are no disclosable events for the trusted entity in the embezzlement risk data and the No branch is taken, then the embezzlement risk analysis device 12 proceeds to step 214.

In step 214, the embezzlement risk analysis device 12 optionally generates an electronic insurance policy document based on the coverage data obtained in step 200 and the risk score generated in step 210. Various aspects of the electronic insurance policy document, such as the associated premium, can be automatically populated by the embezzlement risk analysis device 12 based on the generated risk score and a set of rules applied to insights generated while processing the embezzlement risk data for the trusted entity. Optionally, the electronic insurance policy document can include any number of disclaimers, exclusions, and/or limitations, such as that proceeds will not be paid to the investor for negative performance of the investment or any type of bankruptcy filing on behalf of an entity associated with the investment, for example.

Optionally, the coverage limits and premiums of the insurance policy document or product are continuously priced and/or altered based on the corresponding numerical risk score outputs generated in step 210. The changes can include but are not limited to increasing a premium, denying coverage, limiting aggregate exposure to any trusted entity, and/or limiting insurance coverage for a trusted entity, for example. In yet another example, one or more details of the electronic insurance policy document, such as the deductible and annual premium, can be established at the outset via cover options included in the coverage data and selected by the user of the one of the client computing devices 14(1)-14(n) (e.g., using the coverage GUI 400). Other methods for generating and/or populating the electronic insurance policy document can also be used in other examples.

In step 216, the embezzlement risk analysis device 12 generates and outputs an approval of the insurance underwriting request to the one of the client computing devices 14(1)-14(n) via the communication network 18(1). In examples in which the electronic insurance policy document is generated in step 214, the electronic insurance policy document can be output to the one of the client computing devices 14(1)-14(n) along with the approval in step 212.

Subsequent to generating and outputting the approval in step 216, or denial in step 206, the embezzlement risk analysis device 12 proceeds back to step 200 in this example, and another insurance underwriting request is received in step 200 from the one of the client computing devices 14(1)-14(n) or a different one of the client computing devices 14(1)-14(n). In other examples, one or more of steps 200-216 can be performed in a different order and/or in parallel for any number of insurance underwriting requests received from any number of the client computing devices 14(1)-14(n).

Additionally, the embezzlement risk analysis device 12 can provide the risk score to a third party, such as an insurance company or underwriting entity, which can use the risk score to render an approval or denial decision and/or determine one or more policy parameters. Accordingly, the embezzlement risk analysis device 12 can advantageously facilitate an end-to-end underwriting process at scale or, alternatively or in combination, facilitate underwriting by third party entities by providing risk scores and/or portions of the embezzlement risk data that formed the basis for the risk scores, for trusted entities identified by an investor.

In some examples, the embezzlement risk analysis device 12 can also receive a policy underwritten by such a third party, which can be communicated to one of the client computing devices 14(1)-14(n) in response to the insurance underwriting request received in step 200, such that the requesting one of the client computing devices 14(1)-14(n) interfaces only with the embezzlement risk analysis device 12. In yet other examples, the embezzlement risk analysis device 12 can receive the insurance underwriting request from a third party (e.g., an insurance company) that originally received the request from one of the client computing devices 14(1)-14(n). In these examples, the one of the client computing devices 14(1)-14(n) can interface exclusively with the third party. Other permutations are also possible in other examples.

Referring to FIG. 5, an exemplary flow diagram of an exemplary method for embezzlement risk modeling to facilitate insurance-based asset protection is illustrated. In this example, the embezzlement risk analysis device 12 aggregates embezzlement risk data for one or more trusted entities including managers, advisers, and bank chartered trust employees. The embezzlement risk data is aggregated from embezzlement risk data source devices 16(1)-16(n) hosted by government and independent entities. The embezzlement risk data is obtained for trusted entities identified with an associated designation or CRD number in an insurance underwriting request. The request can be received from one of the client computing devices 14(1)-14(n) that may be operating by a user that has invested financial assets with the identified trusted entities, or from a third party insurance underwriter, for example.

The embezzlement risk analysis device 12 then analyzes the aggregated embezzlement risk data to determine whether each of the trusted entities purportedly having an associated CRD number is registered with the SEC and whether the financial designation(s) for each of the trusted entities purportedly having such financial designation(s) have been approved. If the CRD number(s) are not registered, or no designations are approved, then the process fails and, in this example, a denial message is returned in response to the underwriting request, as described and illustrated in more detail earlier with reference to step 206 of FIG. 2.

However, if the CRD number(s) are registered, and the designation(s) are approved, then the embezzlement risk analysis device 12 determines whether there are disclosable event(s) for the trusted entities in the aggregated embezzlement risk data. If the embezzlement risk analysis device 12 determines that there are no disclosable events for the trusted entities in the embezzlement risk data, then the process passes and, in this example, an approval message is returned in response to the underwriting request, as described and illustrated in more detail earlier with reference to step 216 of FIG. 2.

If the embezzlement risk analysis device 12 determines that there is at least one disclosable event for one or more of the trusted entities, then the embezzlement risk analysis device 12 determines characteristics of the disclosable event(s), and uses the determined characteristics and weighting factors to generate a risk score for each of the trusted entities and/or a cumulative risk score for the trusted entities collectively. In the example illustrated in FIG. 5, the characteristics for each disclosable event include the type (e.g., civil, regulatory, or criminal), whether the disclosable event is securities related, the date, whether a suspension is associated, a fine, a settlement amount, and a severity, although other characteristics can also be used. Additionally, the number of disclosable events can impact the risk score for a trusted entity.

Next, the embezzlement risk analysis device 12 compares the cumulative risk score to a threshold to determine whether the cumulative risk score exceeds the threshold. If the embezzlement risk analysis device 12 determines that the cumulative risk score is below the threshold, then an approval message is returned in response to the underwriting request. Alternatively, if the embezzlement risk analysis device 12 determines that the cumulative risk score is above the threshold, then a denial message is returned in response to the underwriting request.

Additionally, in this example, an optional underwriting decision override is provided. The embezzlement risk analysis device 12 can output details, including the cumulative risk score, to a third party insurance underwriter, or an administrator, that can make a manual or subjective decision regarding whether to underwrite an insurance policy for the investor irrespective of the automated determination that is made based on the cumulative risk score. Also optionally, an electronic insurance policy document can be automatically generated and provided in iterations in which an approval message is returned. The electronic insurance policy document can be generated based on coverage details provided with the underwriting request, for example, although other methods can be used to facilitate execution of an insurance policy document.

Accordingly, with this technology, investor risk is more effectively modeled and analyzed with respect to investing assets with a trusted entity in order to inform an insurance underwriting decision. This technology automatically performs due diligence with respect to an identified trusted entity by obtaining embezzlement risk data from a number of data sources to generate an indication of the risk of investing with trusted entities. The risk indication can be used to make informed underwriting decisions for prospective or current investors in order to facilitate a level of insurance-based asset protection. Accordingly, this technology provides a technical solution to the technology problem of efficiently modeling and analyzing embezzlement risk data in order to more effectively inform insurance underwriting decisions.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for embezzlement risk modeling to facilitate insurance-based asset protection, the method comprising:
retrieving, by an embezzlement risk analysis device, embezzlement risk data for at least one trusted entity in response to an insurance underwriting request received from an underwriting computing device via one or more communication networks, the embezzlement risk data retrieved from one or more embezzlement risk data source devices via another one or more communication networks;
applying, by the embezzlement risk analysis device, one or more weighting factors to one or more characteristics of one or more disclosable events extracted from the retrieved embezzlement risk data to generate at least one risk score; and
providing, by the embezzlement risk analysis device, the risk score, to the underwriting computing device in response to the insurance underwriting request and via the one or more communication networks, as an indication of a risk of loss of financial assets made available to the trusted entity.

2. The method of claim 1, wherein one or more of the characteristics of one or more of the disclosable events comprise a type, a fine amount, a date, a settlement amount, or a severity.

3. An embezzlement risk analysis device, comprising memory comprising programmed instructions stored thereon and one or more processors configured to be capable of executing the stored programmed instructions to:
retrieve embezzlement risk data for at least one trusted entity in response to an insurance underwriting request received from an underwriting computing device via one or more communication networks, the embezzlement risk data retrieved from one or more embezzlement risk data source devices via another one or more communication networks;
apply one or more weighting factors to one or more characteristics of one or more disclosable events extracted from the retrieved embezzlement risk data to generate at least one risk score; and
provide the risk score, to the underwriting computing device in response to the insurance underwriting request and via the one or more communication networks, as an indication of a risk of loss of financial assets made available to the trusted entity.

4. The embezzlement risk analysis device of claim 4, wherein one or more of the characteristics of one or more of the disclosable events comprise a type, a fine amount, a date, a settlement amount, or a severity.

5. A non-transitory computer readable medium having stored thereon instructions for embezzlement risk modeling to facilitate insurance-based asset protection comprising executable code which when executed by one or more processors, causes the one or more processors to:
retrieve embezzlement risk data for at least one trusted entity in response to an insurance underwriting request received from an underwriting computing device via one or more communication networks, the embezzlement risk data retrieved from one or more embezzlement risk data source devices via another one or more communication networks;
apply one or more weighting factors to one or more characteristics of one or more disclosable events extracted from the retrieved embezzlement risk data to generate at least one risk score; and
provide the risk score, to the underwriting computing device in response to the insurance underwriting request and via the one or more communication networks, as an indication of a risk of loss of financial assets made available to the trusted entity.

6. The non-transitory computer readable medium of claim 7, wherein one or more of the characteristics of one or more of the disclosable events comprise a type, a fine amount, a date, a settlement amount, or a severity.

7. A method for embezzlement risk modeling to facilitate insurance-based asset protection, the method comprising:
retrieving, by an embezzlement risk analysis device and from one or more embezzlement risk data source devices, embezzlement risk data for at least one trusted entity in response to an insurance underwriting request received from an underwriting computing device via one or more communication networks;
applying, by the embezzlement risk analysis device, one or more weighting factors to one or more characteristics of one or more disclosable events extracted from the retrieved embezzlement risk data to generate at least one risk score;
determining, by the embezzlement risk analysis device, when the risk score exceeds a stored threshold; and
generating, by the embezzlement risk analysis device, and outputting via the one or more communication networks, a positive insurance underwriting decision in response to the insurance underwriting request, when the determination indicates that the risk score exceeds the stored threshold.

8. The method of claim 7, wherein the insurance underwriting request comprises trusted entity data for the trusted entity and the method further comprises:
authenticating, by the embezzlement risk analysis device, the trusted entity based on a correlation of a Central Registration Depository (CRD) number or one or more designations included in the trusted entity data to determine when the trusted entity is registered or approved; and
generating, by the embezzlement risk analysis device, and outputting via the one or more communication networks, a negative insurance underwriting decision in response to the insurance underwriting request, when the determination indicates that the risk score does not exceed the stored threshold or that the trusted entity is not registered or approved.

9. The method of claim 7, further comprising, when the determination indicates that risk score exceeds the stored threshold:
retrieving, by the embezzlement risk analysis device, coverage data including investment data associated with the financial assets; and
automatically generating, by the embezzlement risk analysis device, and outputting, via the one or more communication networks and in response to the insurance underwriting request, an electronic insurance policy document based on the coverage data and the risk score.

10. The method of claim 7, further comprising:
determining, by the embezzlement risk analysis device, when the embezzlement risk data includes the disclosable events, wherein the risk score is generated and the determination when the risk score exceeds the stored threshold is made, when the determination indicates that the embezzlement risk data includes the disclosable events; and
generating, by the embezzlement risk analysis device, and outputting via the one or more communication networks, a positive insurance underwriting decision in response to the insurance underwriting request, without generating the risk score or determining when the risk score exceeds the stored threshold, when the determination indicates that the embezzlement risk data does not include any disclosable events.

11. An embezzlement risk analysis device, comprising memory comprising programmed instructions stored thereon and one or more processors configured to be capable of executing the stored programmed instructions to:
retrieve, from one or more embezzlement risk data source devices, embezzlement risk data for at least one trusted entity in response to an insurance underwriting request received from an underwriting computing device via one or more communication networks;
apply one or more weighting factors to one or more characteristics of one or more disclosable events extracted from the retrieved embezzlement risk data to generate at least one risk score;
determine when the risk score exceeds a stored threshold; and
generate, and output via the one or more communication networks, a positive insurance underwriting decision in response to the insurance underwriting request, when the determination indicates that the risk score exceeds the stored threshold.

12. The embezzlement risk analysis device of claim 11, wherein the insurance underwriting request comprises trusted entity data for the trusted entity and the one or more processors are further configured to be capable of executing the stored programmed instructions to:
authenticate the trusted entity based on a correlation of a Central Registration Depository (CRD) number or one or more designations included in the trusted entity data to determine when the trusted entity is registered or approved; and
generate, and output via the one or more communication networks, a negative insurance underwriting decision in response to the insurance underwriting request, when the determination indicates that the risk score does not exceed the stored threshold or that the trusted entity is not registered or approved.

13. The embezzlement risk analysis device of claim 11, wherein the one or more processors are further configured to be capable of executing the stored programmed instructions to, when the determination indicates that risk score exceeds the stored threshold:
retrieve coverage data including investment data associated with the financial assets; and
automatically generate and output, via the one or more communication networks and in response to the insurance underwriting request, an electronic insurance policy document based on the coverage data and the risk score.

14. The embezzlement risk analysis device of claim 11, wherein the one or more processors are further configured to be capable of executing the stored programmed instructions to:
determine when the embezzlement risk data includes the disclosable events, wherein the risk score is generated and the determination when the risk score exceeds the stored threshold is made, when the determination indicates that the embezzlement risk data includes the disclosable events; and
generate, and output via the one or more communication networks, a positive insurance underwriting decision in response to the insurance underwriting request, without generating the risk score or determining when the risk score exceeds the stored threshold, when the determination indicates that the embezzlement risk data does not include any disclosable events.

15. A non-transitory computer readable medium having stored thereon instructions for embezzlement risk modeling to facilitate insurance-based asset protection comprising executable code which when executed by one or more processors, causes the one or more processors to:
retrieve, from one or more embezzlement risk data source devices, embezzlement risk data for at least one trusted entity in response to an insurance underwriting request received from an underwriting computing device via one or more communication networks;
apply one or more weighting factors to one or more characteristics of one or more disclosable events extracted from the retrieved embezzlement risk data to generate at least one risk score;
determine when the risk score exceeds a stored threshold; and
generate, and output via the one or more communication networks, a positive insurance underwriting decision in response to the insurance underwriting request, when the determination indicates that the risk score exceeds the stored threshold.

16. The non-transitory computer readable medium of claim 15, wherein the insurance underwriting request comprises trusted entity data for the trusted entity and the executable code when executed by the one or more processors further causes the one or more processors to:
authenticate the trusted entity based on a correlation of a Central Registration Depository (CRD) number or one or more designations included in the trusted entity data to determine when the trusted entity is registered or approved; and
generate, and output via the one or more communication networks, a negative insurance underwriting decision in response to the insurance underwriting request, when the determination indicates that the risk score does not exceed the stored threshold or that the trusted entity is not registered or approved.

17. The non-transitory computer readable medium of claim 15, wherein the executable code when executed by the one or more processors further causes the one or more processors to, when the determination indicates that risk score exceeds the stored threshold:
retrieve coverage data including investment data associated with the financial assets; and
automatically generate and output, via the one or more communication networks and in response to the insurance underwriting request, an electronic insurance policy document based on the coverage data and the risk score.

18. The non-transitory computer readable medium of claim 15, wherein the executable code when executed by the one or more processors further causes the one or more processors to:
determine when the embezzlement risk data includes the disclosable events, wherein the risk score is generated and the determination when the risk score exceeds the stored threshold is made, when the determination indicates that the embezzlement risk data includes the disclosable events; and
generate, and output via the one or more communication networks, a positive insurance underwriting decision in response to the insurance underwriting request, without generating the risk score or determining when the risk score exceeds the stored threshold, when the determination indicates that the embezzlement risk data does not include any disclosable events.
